(19) United States
(12) Patent Application Publication
(10) Pub. No.: US 2025/0066202 A1
(43) Pub. Date: Feb. 27, 2025

(54) METHOD FOR CONVERTING RUBBER WASTE TO FUNCTIONALIZED ACTIVATED CARBON

(71) Applicant: KING FAHD UNIVERSITY OF PETROLEUM AND MINERALS, Dhahran (SA)

(72) Inventor: Tawfik Abdo SALEH, Dhahran (SA)

(73) Assignee: KING FAHD UNIVERSITY OF PETROLEUM AND MINERALS, Dhahran (SA)

(21) Appl. No.: 18/456,174

(22) Filed: Aug. 25, 2023

(51) Int. Cl. C01B 32/324; C01B 32/198; C01B 32/342; C01B 32/36; C08J 11/12; C09C 1/48

(52) U.S. Cl. CPC C01B 32/324; C01B 32/198; C01B 32/342; C01B 32/36; C08J 11/12; C09C 1/482; C01P 2006/90; C08J 2317/00

(57) ABSTRACT

Aspects of the present disclosure are directed to a method for converting rubber waste to a functionalized activated carbon (AC). The method includes pyrolysis of waste/scrap tires to produce activated carbon; (ii) chemical activation of the activated carbon using an oxidizing agent; and (iii) and functionalization of the chemically activated carbon with 1,2,3,4,6-pentagalloylglucose (pentagallic acid ester of glucose) to produce the AC. The method of the present disclosure converts waste-to-value-added products, thereby enhancing profitability by recycling the waste products. Such processes are the source of renewable energy (gas and oil) and valuable by-products.

### BACKGROUND

### Technical Field

The present disclosure is directed to a method for converting rubber waste to valuable products, particularly to a method for converting rubber waste to functionalized activated carbon (AC).

### Description of the Related Prior Art

The description of the related prior art provided herein is for the purpose of generally presenting the context of the disclosure. Work of the presently named inventors, to the extent described in this background section, as well as aspects of the description which may not otherwise qualify as prior art at the time of filing, are neither expressly nor impliedly admitted as prior art against the present invention.

Industrialization and improper waste management have lead to the accumulation of a large amount of waste materials in landfills and storage facilities. A proper waste management strategy is required to better manage the waste such as a “waste-to-wealth strategy”, e.g., a strategy for converting waste material into commercially valuable products. The processes for waste-to-value-added product conversions enhance profitability by recycling waste products that would otherwise be disposed at significant cost. Such processes can be a source of renewable energy (gas and oil) and valuable by-products.

Large amounts of rubber tires are used globally; thus, large amounts of waste tires are available. Tires are made up of copolymers and long-chain polymers of monomer units including styrene, isoprene, and butadiene, that are connected to each other by inclusion of a cross-linking agent such as sulfur in a process called vulcanization. Recycling rubber waste as a management tool is the most widely accepted method, but it is expensive; alternative methods, such as pyrolysis and gasification, are in place to produce valuable products from used tires.

There are many methods to recycle tires. These methods can be classified into methods of grinding the waste mechanically into smaller pieces to produce fine particles without altering the chemical composition, and methods of mechanochemically breaking down the three-dimensional rubber polymer network. Thermal, mechanical, biological, chemical, ultrasonic, and microwave treatments can be used to convert insoluble rubber thermoset polymers into re-processable elastomers. Pyrolysis is a method suitable for tire recycling. Although the technique for pyrolyzing waste rubber tires has advanced significantly, pyrolysis is still only performed on a small scale because there is yet to be a market for the resultant products. The temperature, pressure and residence time used during the pyrolysis process all affect the particle size and product yield of the product. Although the output of pyrolysis gas and oil is known to rise with temperature, high temperatures can reduce the yield. Lower pressure lowers energy consumption and increases the liquid and char yields, and temperatures between 300° C. and 800° C. are considered ideal for char formation.

Tires can be pyrolyzed to provide activated carbon (AC) products for various adsorption applications. AC from waste rubber tires can adsorb different compounds, such as the pollutants from wastewater or impurities from oil and gas. There are various methods of improving the adsorption capacity of finely powdered AC particles. For example, as described herein, AC from waste rubber tires can be synthesized by pyrolysis followed by treatment with activating agents such as zinc chloride and potassium hydroxide.

Rubber waste can be pyrolyzed at 800° C. in a fixed bed reactor to form AC. A physical method of activation using CO₂ in combination with the AC can be used to remove a pesticide (bromopropylate) by adsorption from water. The AC surface area was reported as about 430 m² g⁻with nearly 100% of the pesticide was removed in just 1 h time of the contact time (Zabaniotou A. A., N. Antoniou, G. Stavropoulos “Novel sorbent materials for environmental remediation via depolymerization of used tires,” Desalination and Water Treatment (2014) 1-10). In another study, AC from waste rubber tires was obtained by carbonization and used effectively for the removal of dyes from water. It was reported that temperatures above 770K resulted in a lower yield adsorbent (Edward L. K. Mui, W. H. Cheung, Gordon Mckay “Tyre char preparation from waste tire rubber for dye removal from effluents,” Journal of Hazardous Materials 175 (2010) 151-158).

In another study, waste rubber tires were pyrolyzed in a nitrogen atmosphere at different temperatures for char production (Manchon-Vizuete, E., Macias-Garcia, A., Gisbert, A. N., Fernandez-Gonzalez, C., Gomez-Serrano, “Adsorption of mercury by carbonaceous adsorbents prepared from rubber of tire wastes,” Journal of Hazardous Materials B119 (2005) 231-238). The char was activated by oxygenation at various temperatures and evaluated for the removal of Hg ions from water. The study concluded that the optimum temperature for pyrolysis in nitrogen atmospheres is 550° C. The adsorption process was found to be fast, and equilibrium was achieved after 1 h contact time.

AC was employed as an adsorbent to remove nickel and lead ions from aqueous solutions (Vinod K. Gupta, M. R. Ganjali, Arunima Nayak, B. Bhushan, Shilpi Agarwal “Enhanced heavy metals removal and recovery by mesoporous adsorbent prepared from waste rubber tire,” Chemical Engineering Journal 197 (2012) 330-342). It was reported that the adsorbent had a higher affinity for the lead ions (96% removal), and it was assumed that the adsorption process began with initial surface adsorption and progressed to intra-particle diffusion. The adsorbent's ability to regenerate was identified as a basis for providing an alternative to the pricey commercial AC now used for pollution cleanup.

In another study, granular tire particles were heated at 773K and 1223K, respectively, to carbonize and pyrolyze and form activated carbon (Edward L. K. Mui, W. H. Cheung, Gordon Mckay “Tyre char preparation from waste tire rubber for dye removal from effluents,” Journal of Hazardous Materials, 175 (2010) 151-158). The created product was first treated with acid before being activated by carbon dioxide in a nitrogen atmosphere. The synthetic adsorbent, which had a greater surface area and better yield, was utilized to remove color dyes from wastewater. AC with a high surface area (414 m^{2/}g) was synthesized without pyrolysis in a cost-effective one-step process. The study made use of the thermochemical breakdown of tire granules in a carbon dioxide atmosphere (Quek, A., Balasubramanian, R., “Low-energy and chemical-free activation of pyrolytic tire char and its adsorption characteristics,” J. Air Waste Manag. Assoc., 59, (2009) 747).

Although a few methods for generating AC from waste rubber have been developed in the past, a simple, cost-effective manner is still needed for converting rubber waste to valuable products such as functionalized AC.

### SUMMARY

In an exemplary embodiment, a method for converting rubber waste to a functionalized activated carbon (AC), is described. The method includes pyrolyzing the rubber waste in a crucible by first heating the rubber waste to a first temperature in a range of 300° C.±10° C. and maintaining the first temperature for a period of 2 h±0.2 h to form a first residue, then second heating the first residue to a temperature in a range of 600° C.±50° C. and maintaining the second temperature for a period of 2 h±0.2 h to form a solid carbon, wherein the crucible has a permeable bottom configured to permit an oil product formed during the pyrolyzing to drain and an open top configured to permit a gaseous product formed during the pyrolyzing to separate and leave the solid carbon oxidizing the solid carbon with nitric acid to form an oxidized product; functionalizing the oxidized product with 1,2,3,4,6-pentagalloylglucose in a mixture including the oxidized product, the 1,2,3,4,6-pentagalloylglucose, water and ethanol, by heating the mixture in the presence of N,N′-dicyclohexylcarbodiimide to form a reaction product including the functionalized AC; and separating the functionalized AC from the reaction product.

In some embodiments, the oil product includes one or more of a non-aromatic hydrocarbon, an aromatic hydrocarbon, an alkanes, an alkene, a ketone, and an aldehyde.

In some embodiments, the gas product includes one or more of hydrogen, carbon dioxide, carbon monoxide, methane, ethane, and butane.

In some embodiments, the functionalized AC includes graphene covalently bonded to a pentagalloylglucose unit.

In some embodiments, the graphene is covalently bonded to a pentagalloylglucose unit through an ester bond.

In some embodiments, the graphene includes a plurality of hydroxyl groups.

In some embodiments, the graphene includes a plurality of C1 carboxyl groups.

In some embodiments, the functionalized AC includes mainly graphene and graphene oxides.

In some embodiments, the functionalized AC includes graphene and graphene oxides.

In some embodiments, the functionalized AC includes a compound of formula:

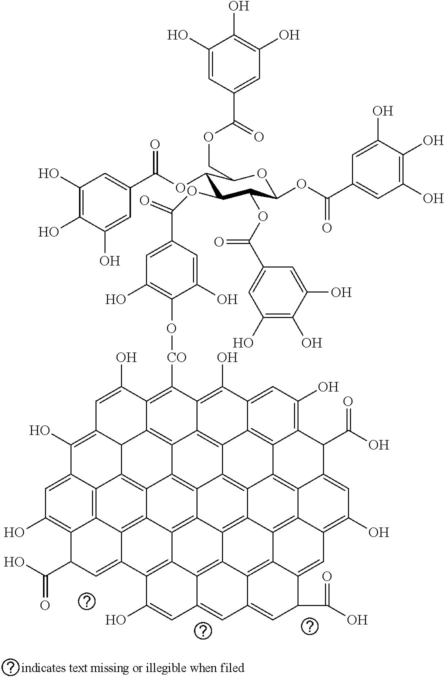

In some embodiments, the first heating includes heating the rubber waste from a temperature of 25° C. to the first temperature at a rate of at 5° C./min.

In some embodiments, the second heating includes heating the first residue from the first temperature to the second temperature at a rate of at 5° C./min.

In some embodiments, the functionalizing includes heating the mixture at a reflux temperature of 90° C.±5° C. for 5-10 h under reflux.

In some embodiments, the method includes pyrolyzing the rubber waste in air.

In some embodiments, the crucible is a cylindrical ceramic tube having a bottom half portion partially encompassed by a resistive heater and a top portion connected to an adsorber, wherein the bottom portion is configured to separate the oil product by gravity into an oil vessel.

In some embodiments, the cylindrical ceramic tube, the adsorber, and the oil vessel define an enclosed space.

In some embodiments, during oxidizing the solid carbon with nitric acid, a nitric acid stream is injected into the permeable bottom of the ceramic tube and the ceramic heater is heated to a temperature of 50° C.-100° C.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a flowchart depicting a method for converting rubber waste to a functionalized activated carbon (AC), according to certain embodiments;

FIG. 2 shows a schematic illustration depicting the method for converting waste tires to carbons and other value-added products, according to certain embodiments;

FIG. 3 is a flowchart depicting a method for converting waste tires to carbon black, according to certain embodiments; and

FIG. 4 shows the chemical structure of an AC modified/functionalized with 1,2,3,4,6-pentagalloylglucose, according to certain embodiments.

### DETAILED DESCRIPTION

When describing the present disclosure, the terms used are to be construed in accordance with the following definitions, unless a context dictates otherwise.

Embodiments of the present invention will now be described more fully hereinafter with reference to the accompanying drawings wherever applicable, in that some, but not all embodiments of the disclosure are shown.

In the drawings, like reference numerals designate identical or corresponding parts throughout the several views. Further, as used herein, the words “a,” “an” and the like generally carry a meaning of “one or more,” unless stated otherwise.

Furthermore, the terms “approximately”, “approximate”, “about,” and similar terms generally refer to ranges that include the identified value within a margin of 20%, 10%, or preferably 5%, and any values therebetween.

The use of the terms “include,” “includes”, “including,” “have,” “has,” or “having” should be generally understood as open-ended and non-limiting unless specifically stated otherwise.

As used herein, “particle size” refers to the length or longest dimension of a particle.

As used herein, the term “pyrolysis” refers to breaking down a hydrocarbon material into its constituent parts, viz., forms of carbon and various hydrocarbon compounds having a broad range of molecular weights.

As used herein, the term “oxidation” refers to the loss of electrons or increase in the oxidation state of a molecule, atom, or ion in a chemical reaction. Oxidation could be carried out using an oxidizing agent, such as ozone, hydrogen peroxide, halogens like chlorine, bromine, strong acids like nitric acid, perchloric acid, and sulfuric acid, ionic oxidizing agents such as permanganate ion, chromate ion, and dichromate ion.

As used herein, “activated carbon (AC)”, also called activated charcoal, is a form of carbon that is an effective adsorbent and is usually used for filtration of contaminants from water and air, among other applications.

Aspects of the present disclosure are directed to a method for converting rubber waste to a functionalized activated carbon (AC). Rubber waste refers to any refuse or unwanted material made of synthetic or natural rubber, generally, the byproduct of rubber processing. Most of the rubber waste generated is from tires of automobiles, trucks, bikes, and motorcycles. Preferably the rubber waste includes polymers derived from one or more of ethylene, propylene, chloroprene, isoprene, butadiene and other diene monomers. Other sources of rubber waste include clothing, footwear, gaskets, and furniture.

The method includes three steps: (i) pyrolysis of waste/scrap tires to produce activated carbon; (ii) chemical activation of the activated carbon using an oxidizing agent; and (iii) and functionalization of the chemically activated carbon with 1,2,3,4,6-pentagalloylglucose (pentagallic acid ester of glucose) to produce the AC. The method of the present disclosure converts waste to value-added products thereby recycling rubber waste products in a simple, cost-effective, and an environmentally friendly manner.

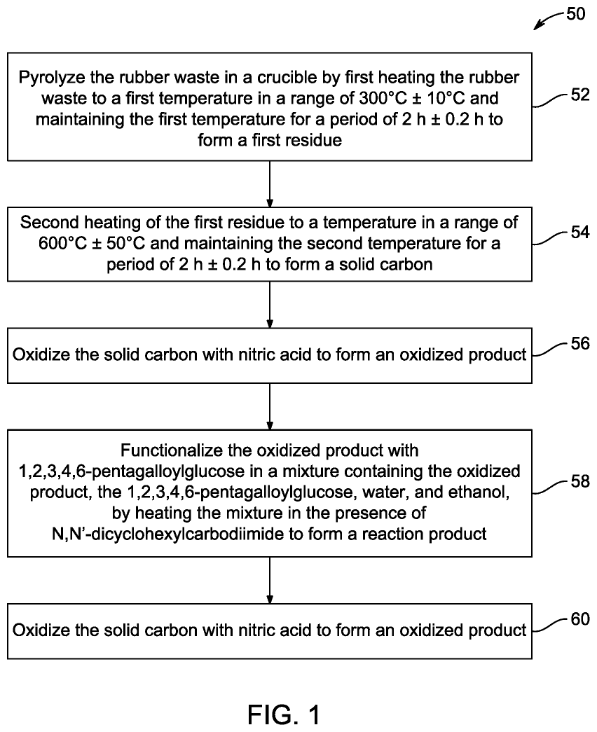

FIG. 1 illustrates a flow chart of method 50 for converting rubber waste to a functionalized, activated carbon. The order in which the method 50 is described is not intended to be construed as a limitation, and any number of the described method steps can be combined in any order to implement the method 50.

At step 52, the method 50 includes pyrolyzing the rubber waste in a crucible by first heating the rubber waste to a first temperature in a range of 300° C.±10° C. and maintaining the first temperature for a period of 2 h±0.2 h to form a first residue. In an embodiment, the first heating includes heating the rubber waste from a temperature of 25° C. to the first temperature of preferably 290° C., preferably 295° C., preferably 300° C., preferably 305° C., and preferably 310° C. at a rate of 5° C./min. In a preferred embodiment, the pyrolysis of rubber waste is done in the crucible by first heating the rubber waste to the first temperature of 300° C. The first temperature is maintained for a period of preferably 1.8 h, preferably 2 h, and preferably 2.2 h to form a first residue. In a preferred embodiment, the first temperature is maintained for a period of 2 h. In an embodiment, the pyrolysis is carried out in air. In a preferred embodiment the process is carried out in a gas stream including alternating flows of inert and active gases. For example, initial heating (up to a temperature of 100° C.) is carried out in an inert gas stream (e.g., N₂, Ar, etc.). At temperature above 100° C. the composition of the gas flow is alternated between inert and active (e.g., comprising an oxidizing agent, preferably O₂ gas). As the temperature is ramped the composition of the gas flows is altered at each 5° C. interval (alternately at intervals of 10° C., 15° C., 20° C., 25° C. or 50° C.). Alternating the gas flows in a repetitive inert-active manner permits the rubber waste to degas adsorbed fluids and volatile solids without excessive oxidation of these compounds. In the absence of alternating gas flows the product gases and oils may contain large amounts of undesirable side products formed as adsorbed fluids and volatile solids catalyze side reactions.

At step 54, the method includes second heating the first residue to a temperature in a range of 600° C.±50° C. and maintaining the second temperature for a period of 2 h±0.2 h to form a solid carbon. In an embodiment, the second heating included heating the first residue from the first temperature to the second temperature of preferably 550° C., preferably 560° C., preferably 570° C., preferably 580° C., preferably 590° C., preferably 600° C., preferably 610° C., preferably 620° C., preferably 630° C., preferably 640° C., and preferably 650° C. at a rate of at 5° C./min. In a preferred embodiment, the second heating included heating the first residue from the first temperature to the second temperature of 600° C. at a rate of at 5° C./min. The temperature was maintained for a period of preferably 1.8 h, preferably 2 h, and preferably 2.2 h to form a first residue. In a preferred embodiment, the temperature was maintained for a period of 2 h.

As is the case during the first heating, the second heating is preferably carried out in a gas stream including alternating flows of inert and active gases. For example, heating (up to the second temperature) is first carried out in an inert gas stream (e.g., N₂, Ar, etc.). Upon heating, at higher temperatures the composition of the gas flow is alternated between inert and active (e.g., comprising an oxidizing agent, preferably O₂ gas. As the temperature is ramped the composition of the gas flows is altered at each 5° C. interval (alternately at intervals of 10° C., 15° C., 20° C., 25° C. or 50° C.). Alternating the gas flows in a repetitive inert-active manner permits the rubber waste to degas adsorbed fluids and volatile solids without excessive oxidation of these compounds. In the absence of alternating gas flows the product gases and oils may contain large amounts of undesirable side products formed as adsorbed fluids and volatile solids catalyze side reactions.

In both the steps as described above, pyrolysis may be performed by placing the mixed powders into a furnace such as a tube furnace, for example, in a ceramic crucible (e.g., an alumina crucible) or other forms of containment, and heating to the temperatures described above. The furnace is preferably equipped with a temperature control system, which may provide a heating rate of up to 50° C./min, or preferably up to 40° C./min, or preferably up to 30° C./min, preferably up to 20° C./min, preferably up to 10° C./min, preferably up to 5° C./min. The furnace may also be equipped with a cooling accessory such as a cooling air stream system, or a liquid nitrogen stream system, which may provide a cooling rate of up to 20° C./min, or preferably up to 15° C./min, or preferably up to 10° C./min.

In an embodiment, the crucible has a permeable bottom configured to drain an oil product formed during the pyrolysis. In an embodiment, the oil product contains one or more of a non-aromatic hydrocarbon, an aromatic hydrocarbon, alkanes, alkene, ketones, and an aldehyde. The crucible further includes an open top configured to permit a gaseous product formed during the pyrolysis to separate and leave the solid carbon. In an embodiment, the gas product includes one or more of hydrogen, carbon dioxide, carbon monoxide, methane, ethane, and butane. The crucible is a cylindrical ceramic tube having a bottom half portion partially encompassed by a resistive heater and a top portion connected to an adsorber. The bottom portion is configured to separate the oil product by gravity into an oil vessel. The cylindrical ceramic tube, the adsorber, and the oil vessel define an enclosed space.

At step 56, the method 50 includes oxidizing the solid carbon with nitric acid to form an oxidized product. For this purpose, a nitric acid stream is injected into the permeable bottom of the ceramic tube and the ceramic heater is heated to a temperature of 50° C.-100° C., preferably 60° C., preferably 70° C., preferably 80° C., preferably 90° C., and preferably 100° C. In a preferred embodiment, the oxidization (or chemical activation) was done using nitric acid, e.g., 2-6 M, at 90° C. The activation (or oxidization) step is helps with functionalization as ACs are based on a solid matrix having good mechanical properties; however, without functionalization by treatment with acid the AC may not have adequate chemical activity, i.e., a sufficient number of active centers. The activation of AC helps to effectively tune its properties. Other suitable examples of chemicals used for the activation of AC include sulfonic acid, phosphoric acid, sulfuric acid, hydrogen peroxide, potassium permanganate, and mixtures thereof.

At step 58, the method 50 includes functionalizing the oxidized product with 1,2,3,4,6-pentagalloylglucose in a mixture including the oxidized product, the 1,2,3,4,6-pentagalloylglucose, water, and ethanol, by heating the mixture in the presence of N,N′-dicyclohexylcarbodiimide to form a reaction product including the functionalized activated carbon. Other examples of catalysts used for modification of AC include N,N′-diisopropylcarbodiimide (DIC), N-(3-dimethylaminopropyl)-N′-ethyl carbodiimide (EDC), polydimethylsiloxane (PDMS), polymethylhydrosiloxane (PMHS), 2,6,6-tetramethylpiperidine-1-oxyl (TEMPO), etc. In an embodiment, the functionalization includes heating the mixture at a reflux temperature of 90° C.±5° C., preferably 85° C., preferably 90° C., preferably 95° C. for 5-10 h, preferably 5 h, preferably 6 h, preferably 7 h, preferably 8 h, preferably 9 h, and preferably 10 h under reflux. In a preferred embodiment, the functionalization includes heating the mixture at a reflux temperature of 90° C. for 6 h. The reaction product is functionalized with 1,2,3,4,6-pentagalloylglucose.

In an embodiment, the functionalized activated carbon includes a compound of formula (I). In an embodiment, the functionalized activated carbon includes graphene and graphene oxides. Graphene is an allotrope of carbon that includes a single layer of atoms assembled in a hexagonal lattice nanostructure. In an embodiment, the graphene includes a plurality of C1 carboxyl groups. In an embodiment, the graphene includes a plurality of hydroxyl groups. The functionalized activated carbon includes graphene covalently bonded to a pentagalloylglucose unit, preferably through an ester bond.

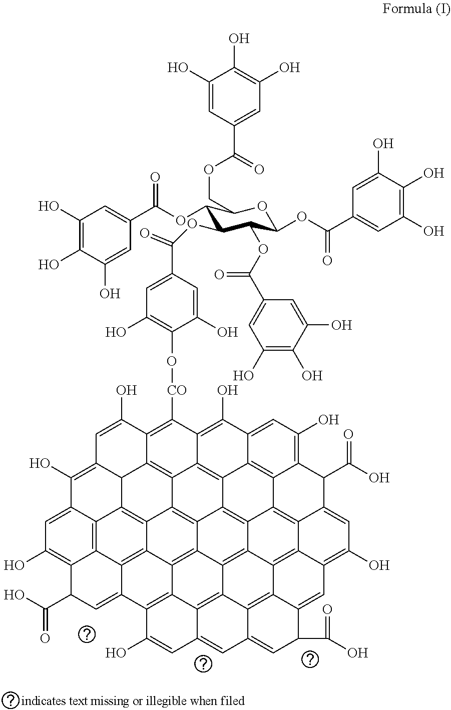

At step 60, the method 50 includes separating the functionalized activated carbon from the reaction product. Centrifugation technique was used for the separation purpose. Other suitable examples of separation techniques include filtration, precipitation, masking, chromatography, distillation, extraction, and volatilization, and these methods are used depending on the physical/chemical properties of the analyte.

### EXAMPLES

The following examples demonstrate a method for converting rubber waste to a functionalized activated carbon (AC), as described herein. The examples are provided solely for illustration and are not to be construed as limitations of the present disclosure, as many variations thereof are possible without departing from the spirit and scope of the present disclosure.

### Example 1: Method for Converting Waste Tires to Carbons and Other Products

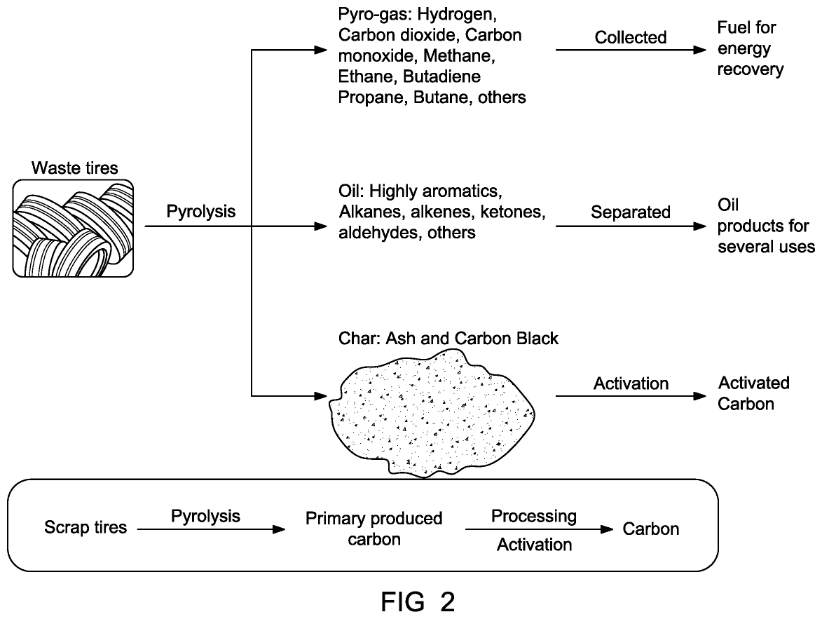

A method suitable for converting waste tires to carbon products and other products is the thermal decomposition of rubber in a closed system. The method results in the production of several valuable materials. (1) Solid remains such as ash, and carbon black for use as filler materials. These materials can be further activated to obtain activated carbon (AC). (2) Oil—which includes of non-aromatics, aromatics, highly aromatics, oxygen, nitrogen, and sulfur-containing compounds—namely, alkanes, alkenes, ketones, aldehydes, and others. (3) Pyro-gas, which includes H₂S, carbon oxides (carbon dioxide and carbon monoxide), hydrocarbons (methane, ethane, propane, butane, butadiene), and hydrogen for reuse in petrochemical industries. The gases produced are purified using appliances such as wet and spray-dry scrubbers and can be used as fuel for energy recovery. A schematic illustration depicting the method for converting the waste tires to carbons and other products is described in FIG. 2.

### Example 2: Procedure for Converting Scrap Tires to Primary Produced Carbon

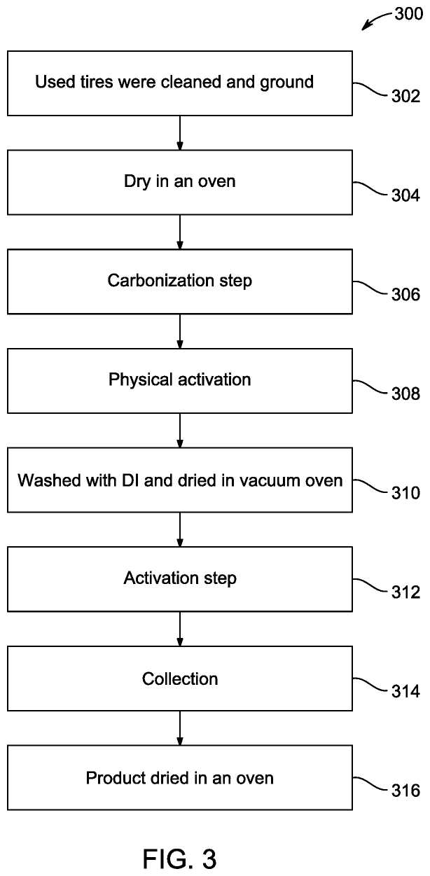

Referring to FIG. 3, the steps for converting waste rubber tires into carbon black is described. The process involves two steps: (i) pyrolysis of scrap tires to produce primary produced carbon; and (ii) processing/activating the primary produced carbon to produce carbon black. The steps involved in the pyrolysis of scrap tires are described below.

Waste rubber tires were collected and cut into small pieces while the iron wires were detached from the tire and removed. The waste rubber tires pieces were then thoroughly cleaned and washed with deionized water and acetone to remove impurities till the waste rubber tires became neat and clean (302). The material was dried in an oven at 130° C. for 3 h (304). The waste rubber tire pieces were then cut into smaller pieces to fit into the crucible. The crucible was designed to have a hole to separate the oil from the bottom, and the crucible also has a lid connected from the top with a tube to allow gases to be collected and separated. The solid products remain inside the crucible. Approximately 100 g of the waste rubber tire was taken for the treatment, then kept inside batch adsorber in air atmosphere, and the temperature increased gradually at 5° C./min till 300° C. The oil and gases were slowly collected. The temperature was maintained for 2 h to allow for separation of the oil and gas. Then, the temperature was increased gradually at 5° C./min till 600° C. Then the temperature was kept at this temperature for 2 h to allow the completeness of the separation of the products and the formation of the ash or carbon (306). Then, the system was allowed to cool. The % recovery of carbon black, gases, and liquid hydrocarbons was calculated. The % recovery was found to be 13% gases, 40% oil, and 47% carbon black. The crucible was taken out of the batch adsorber, and the carbon black (also referred to as adsorbent) was allowed to cool and then collected and later ground to fine particles using a pestle and mortar (308).

The following formulas were used for the calculation of percentage recovery:

$$\% Recovery = \frac{amount of pure product recovered}{amount of crude material used} \times 100$$

The adsorbent was washed with deionized water and dried in an oven at 120° C. overnight (310).

### Example 3: Oxidation of the Synthesized Activated Carbon (AC)

The steps involved in processing/activating the primary produced carbon (as described in Example 2) to produce carbon/carbon black is herein described. In continuation with FIG. 3, the adhering impurities on the surface of the adsorbent were oxidized upon treatment with a hydrogen peroxide solution. The material was washed with deionized water and dried in a vacuum oven.

Chemical activation was conducted on the prepared carbon black using 6 M HNO3 at 90° C. For this purpose, carbon black was added to the round bottom flask. About 300 ml HNO₃ was then added to the round bottom flask. The setup was then stirred and allowed to stand for 3h in a reflux condenser at 90° C. and later allowed to cool to room temperature (312). The AC was then separated by filtration (314), and centrifugation. The AC was washed thoroughly to remove traces of acids or impurities and further dried at 110° C. overnight (316).

### Example 4: Functionalization of the AC

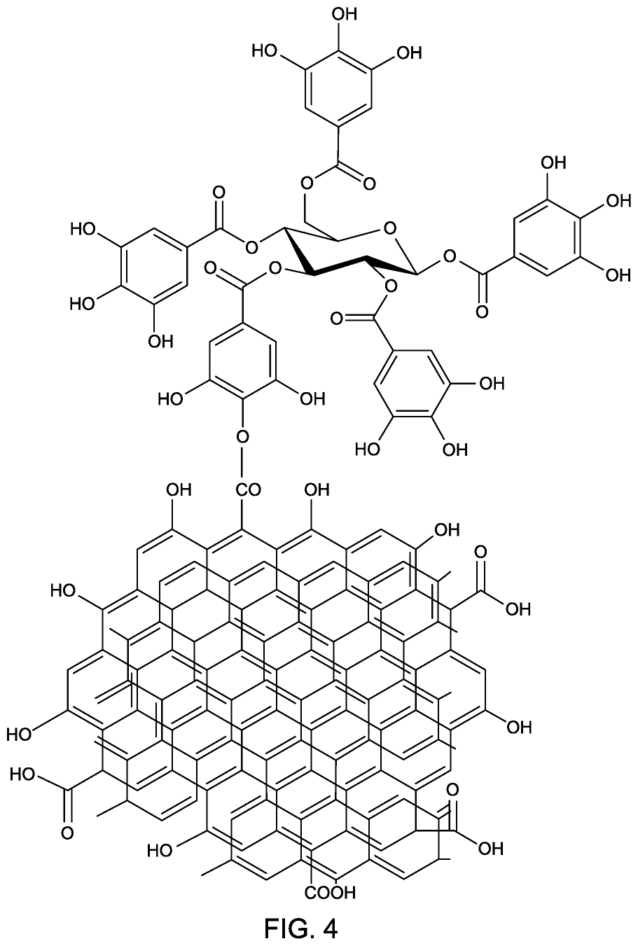

AC was further functionalized (modified) with 1,2,3,4,6-pentagalloylglucose (pentagallic acid ester of glucose). Chemical activation was conducted on the prepared AC using 1,2,3,4,6-pentagalloylglucose. For this purpose, about 10 g of the prepared AC was added into a round bottom flask and dispersed in 200 mL of distilled water. Then, a solution containing 5 g of 1,2,3,4,6-pentagalloylglucose in 100 ml distilled water and in the presence of 20 mL ethanol was prepared and added to the round bottom flask. The system was stirred and heated for 6 h at 90° C. under reflux in the presence of 0.2 g of N,N′-dicyclohexylcarbodiimide (DCC) as a catalyst. After heating for 6 h, the system was allowed to cool; and the product was separated by centrifugation. The product was then dried to obtain the AC functionalized with 1,2,3,4,6-pentagalloylglucose (FIG. 4).

The activated carbon functionalized with 1,2,3,4,6-pentagalloylglucose, produced by the method of the present disclosure, is economically viable and can contribute towards safeguarding the environment and human health. It may be used for several applications, such as the removal of different pollutants from wastewater.

Numerous modifications and variations of the present invention are possible in light of the above teachings. It is, therefore, to be understood that within the scope of the appended claims, the invention may be practiced otherwise than as specifically described herein.

1. A method for converting rubber waste to a functionalized activated carbon (AC), comprising:
pyrolyzing the rubber waste in a crucible by:
first heating the rubber waste to a first temperature in a range of 300° C.±10° C. and maintaining the first temperature for a period of 2 h±0.2 h to form a first residue, then
second heating the first residue to a temperature in a range of 600° C.±50° C., and
maintaining the second temperature for a period of 2 h±0.2 h to form a solid carbon,
wherein the crucible has a permeable bottom configured to permit an oil product formed during the pyrolyzing to drain and an open top configured to permit a gaseous product formed during the pyrolyzing to separate and leave the first residue and the solid carbon;
oxidizing the solid carbon with nitric acid to form an oxidized product;
functionalizing the oxidized product with 1,2,3,4,6-pentagalloylglucose in a mixture comprising the oxidized product, the 1,2,3,4,6-pentagalloylglucose, water and ethanol, by heating the mixture in the presence of N,N′-dicyclohexylcarbodiimide to form a reaction product comprising the functionalized AC; and
separating the functionalized AC from the reaction product.

2. The method of claim 1, wherein the oil product comprises one or more of a non-aromatic hydrocarbon, an aromatic hydrocarbon, an alkane, an alkene, a ketone, and an aldehyde.

3. The method of claim 1, wherein the gas product comprises one or more of hydrogen, carbon dioxide, carbon monoxide, methane, ethane, and butane.

4. The method of claim 1, wherein the functionalized AC comprises graphene covalently bonded to a pentagalloylglucose unit.

5. The method of claim 4, wherein the graphene is covalently bonded to a pentagalloylglucose unit through an ester bond.

6. The method of claim 4, wherein the graphene comprises a plurality of hydroxyl groups.

7. The method of claim 4, wherein the graphene comprises a plurality of C1 carboxyl groups.

8. The method of claim 1, wherein the functionalized AC comprises mainly graphene and graphene oxides.

9. The method of claim 1, wherein the functionalized AC comprises graphene and graphene oxides.

10. The method of claim 1, wherein the functionalized AC comprises a compound of formula:

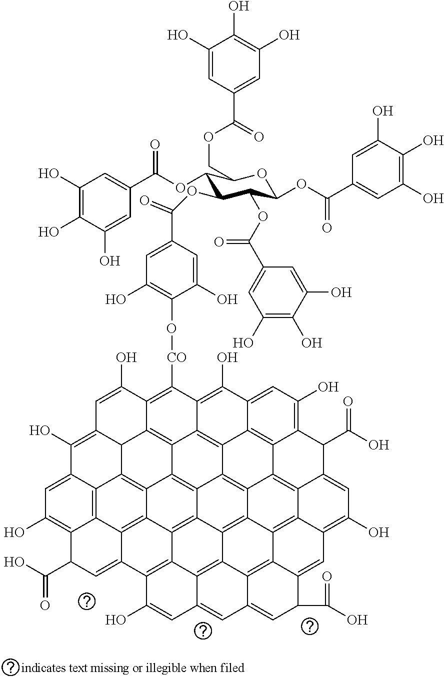

11. The method of claim 1, wherein the first heating comprises heating the rubber waste from a temperature of 25° C. to the first temperature at a rate of 5° C./min in alternating flows of an inert gas stream and an O₂-containing gas stream.

12. The method of claim 1, wherein the second heating comprises heating the first residue from the first temperature to the second temperature at a rate of 5° C./min, wherein the second heating is carried out in alternating flows of an inert gas stream and an O₂-containing gas stream.

13. The method of claim 1, wherein the functionalizing includes heating the mixture at a temperature of 90° C.±5° C. for 5-10 hr under reflux.

14. The method of claim 1, wherein the pyrolyzing is carried out in air.

15. The method of claim 1, wherein the crucible is a cylindrical ceramic tube having a bottom half portion partially encompassed by a resistive heater and a top portion connected to an adsorber, wherein the bottom portion is configured to separate the oil product by gravity into an oil vessel.

16. The method of claim 15, wherein the cylindrical ceramic tube, the adsorber, and the oil vessel define an enclosed space.

17. The method of claim 1, wherein during the oxidizing a nitric acid stream is injected into the permeable bottom of the ceramic tube and the ceramic heater is heated to a temperature of 50° C.-100° C.
